(19) United States
(12) Patent Application Publication
(10) Pub. No.: US 2007/0226056 A1
(43) Pub. Date: Sep. 27, 2007

(54) Handheld device for use at point of sale, checkout device and system and method for tracking advertising effectiveness

(75) Inventors: Roger Robert Belanger, Dover, NH (US); Thomas Bowen Clarke, Durham, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Americas, Inc., Dover, NH (US)

(21) Appl. No.: 11/388,173

(22) Filed: Mar. 23, 2006

(51) Int. Cl. G06Q 30/00

(52) U.S. Cl. 705/14

(57) ABSTRACT

A method for receiving advertising data at a point-of-sale includes inputting good data related to a good at a store checkout via store employee or a store scanner and comparing the good data to advertising data in a handheld device, the advertising data having been scanned by a customer from a print advertisement with the handheld device. The advertising data related to the good is received at the store checkout, as is a payment from the customer for the good at the store checkout. The received advertising data and information related to the payment from the store checkout is then forwarded. A handheld device, checkout device and system and other methods are also provided.

The present invention relates generally to printed materials with advertising and to handheld devices such as scanners for scanning printed materials.

U.S. Pat. Nos. 6,448,979 and 6,753,883, both hereby incorporated by reference herein, describe printed medium activated interactive communication of multimedia information, including advertising. A scanner and a receiver, which may be a single device, communicate with a portal server to play multimedia sequence information received from the portal server. Advertisements may be printed with a machine readable code such as a barcode including a high density bar code and the data from the code may be read by the scanner. The code contains link information corresponding to provider information and may be an alphanumeric sequence. The sequence may activate and result in the playing of multimedia sequence information. The scanner the receiver or the portal server can translate the link information into a network address, so that the multimedia sequence information can be played. Additionally or in the alternative, the network address information can point to a file containing executable computer code and displayed on the receiver or scanner. The system contemplates using additional code types such as benefit redemption information, rebate information and coupon information. The system may also collect and manage code that lacks link information, such as a UPC code. The person can take the UPC information home and get information on the product, a coupon, or other benefit redemption information.

User input information may be stored in the scanner memory. A communications bridge can send the link information and the user input information to the receiver and via a network to the portal server. The system also is capable of allowing print advertisers to track their impressions to execution and to collect demographic information about the person performing the scan through a tracking module. The tracking module is further capable of tracking the transaction value of e-commerce transactions originating from a specific publication, type of publication, or provider and calculate fee percentages based on the transaction. The scanner may have clock which can track the time the ad was scanned.

U.S. Pat. No. 6,896,182 is also incorporated by reference herein and described a card verification system in which a card identification code is registered. A read unit reads the card identification code from the card. A verification apparatus verifies the card only when an existing place of the read unit belongs to an area corresponding to the card identification code. The card is a card used for settlement, and is used when the card identification code is read by the read unit. The use place of the card is coincident with the existing place of the read unit. By adding the use place of the card to a verification condition of the card, unjust use of the card can be prevented. This patent also describes a mobile remote operation point-of-sale terminal as disclosed in Japanese Laid Open Patent Application (JP-A-Heisei 11-500550). In an accounting system, a portable radio accounting terminal is provided in which a user inputs transaction data of dealings using keypad, a UPC bar code of the goods is read by a CCD sensor, a credit card, a debit card and a smart card of the user can be read. The portable radio accounting terminal transmits the dealings and card data to a central network controller via a radio communication network. The central network controller transmits to the host computer in the accounting facilities which processes the card data and the dealings in real time in order. The accounting facilities sends back confirmation data to the central network controller and send back to the radio accounting terminal via the radio communication network. Thus, the radio accounting terminal issues the printed receipt of the dealings to the user.

FIG. 1 describes the existing coupon redemption system for clipped coupons used in the food industry. A manufacturer 10 of a good 12 sends the goods to a retailer 14 and sends coupon information to a coupon agent 16. The coupon agent 16 provides design and printing services as indicated generally at 20, with a customer or consumer 22 clipping the printed coupons. The customer then redeems the coupons at the retailer 14. A checkout device scans the coupons barcode and compares the coupons with a database of the food market industry 24. Retailer 14 sends the paper coupons to a clearinghouse 26, which provides feedback to the coupon agent 16. The feedback can provide advertising information such as identifying the advertisement where the coupon was clipped and limited information on the consumer. The manufacturer, also an advertiser, thus can obtain some information on the effectiveness of its printed coupon advertisements.

### SUMMARY OF THE INVENTION

The above-described systems have the disadvantage that the system cannot easily track or analyze the effectiveness of advertising at most points-of sale.

The present invention provides a method for receiving advertising data at a point of sale comprising:

inputting good data related to a good at a store checkout via store employee or a store scanner;

comparing the good data to advertising data in a handheld device, the advertising data having been scanned by a customer from a print advertisement with the handheld device;

receiving the advertising data related to the good at the store checkout;

receiving a payment from the customer for the good at the store checkout; and

forwarding the received advertising data and information related to the payment from the store checkout.

By permitting receiving of advertising data and sales of actual goods at store locations, the effectiveness of print advertisements advantageously can be monitored even when the sales transaction is not via e-commerce. All types of stores may be outfitted to receive the advertising data from a handheld scanner, and thus all types of transactions can be followed.

The present invention also provides a store checkout device comprising:
a communications interface for receiving advertising data from a handheld device used by a store customer to scan print advertisements, and
a processor for receiving sales information of products purchased by the store customer and forwarding the advertising data and related actual sales data to the advertiser.

The present invention also provides a customer handheld device for use at a store checkout comprising:

an input device;

a display;

an interface for a scanner for scanning printed advertising data;

a memory for storing the advertising data;

a processor for receiving input data from the input device and providing the display with display information related to the advertising data; and

a communications interface for interacting with a store checkout device and the processor;

the processor receiving a command from the store checkout device or the customer via the input device to identify the advertising data related to a good purchased at the point-of-sale, and subsequently sending the related advertising data to the store checkout device.

At checkout, either the user via the input device or the processor via the checkout device can identify which of the stored advertising data in the handheld device relates the good purchased. For example, the user can scroll through the advertising data and identify which data relates to the goods at checkout and then send it to the checkout device, for example by hitting a button of the input device. Alternately, the checkout device, which for example could have scanned the barcodes of the goods purchased, could send a command to have the processor identify any advertising data stored in the handheld device related to the goods being purchased.

The present invention also provides a system for tracking advertising effectiveness comprising:

a plurality of the handheld devices having scanned advertising data from printed advertisements of advertisers; and

a plurality of checkout devices in stores, the checkout devices having a communications interface to provide the advertising data and actual sales information to the advertiser.

The present invention also provides a method for tracking advertising effectiveness comprising:

placing an advertisement for goods in a printed publication, the advertisement including advertising data to be scanned by a handheld scanner of a customer;

sending the goods to stores; and

receiving the advertising data for the goods and store sales information related to the goods, the advertising data having been provided at a store checkout device of the goods.

### BRIEF DESCRIPTION OF THE DRAWINGS

FIG. 1 shows a prior art coupon clearinghouse system.

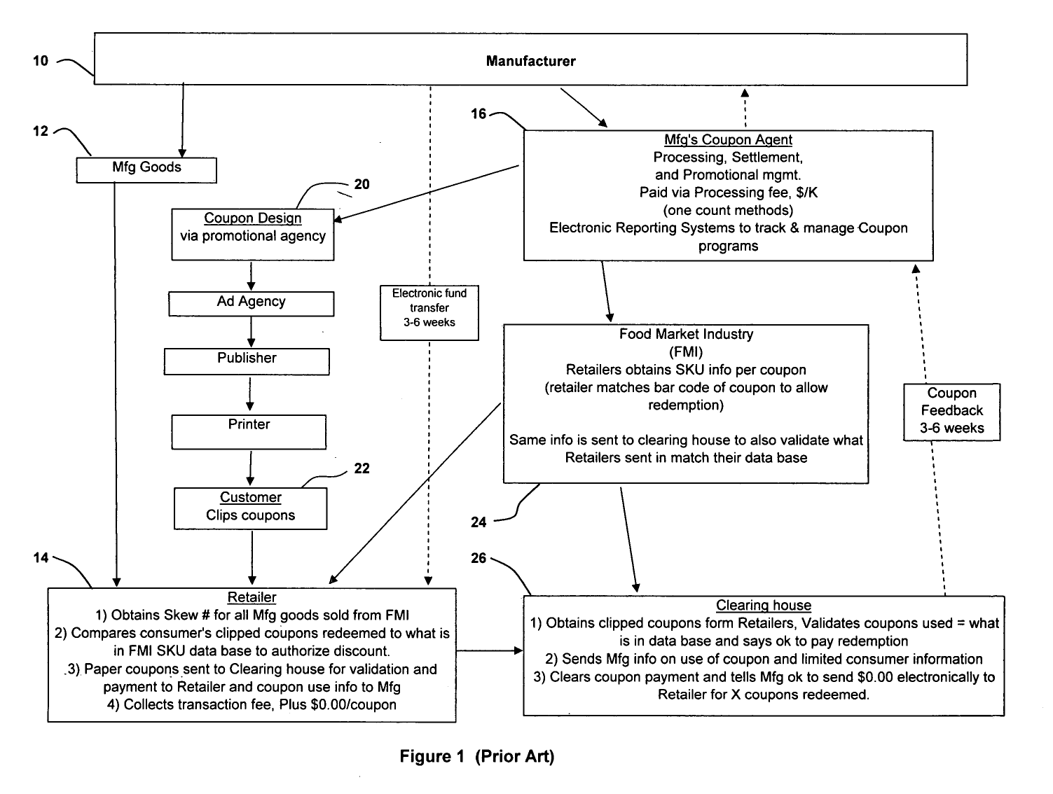

The present invention will be described further with respect to the drawings in which:

FIG. 2 shows a schematic of one embodiment of a system of the present invention;

FIG. 3 shows a flowchart of one embodiment of a method of the present invention; and

FIG. 4 shows one embodiment of the handheld device of the present invention.

### DETAILED DESCRIPTION

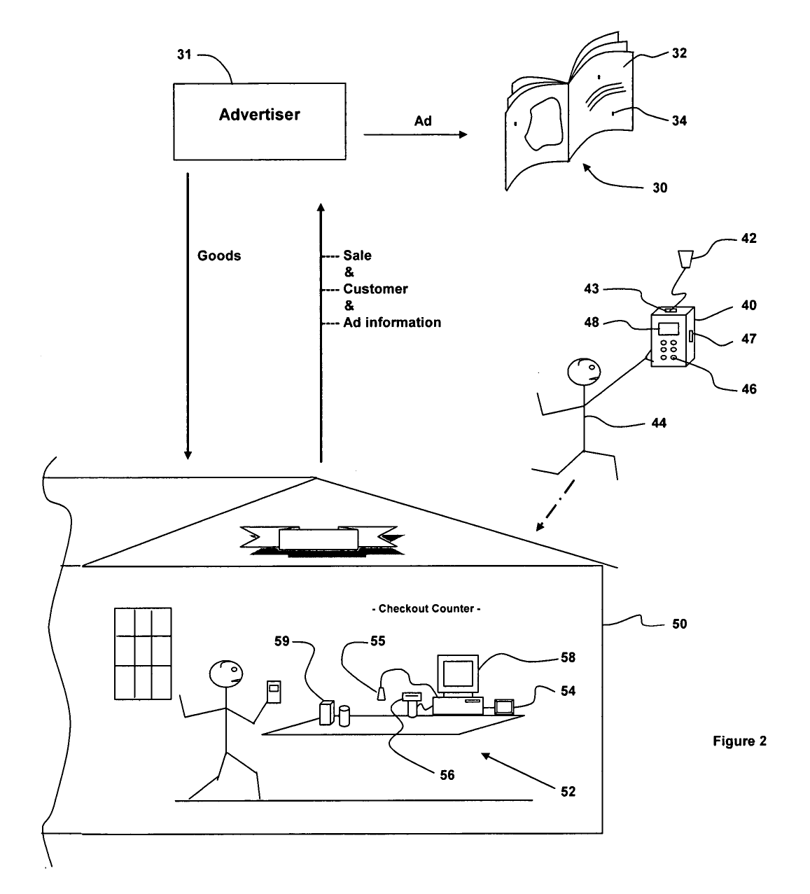

FIG. 2 shows a general overview of one embodiment of the present invention. An advertisement 32 from an advertiser 31 is printed for example in a magazine 30. Advertising data 34, such as the magazine name, page and advertiser identification information can be provided, for example in a code form as described in incorporated by reference U.S. Pat. No. 6,448,979. A potential customer 44 has a handheld device 40 for example an IPOD from Apple, or cell phone, the handheld device having a detachable scanner 42 capable of scanning the printed advertising data 34 and inputting the advertising data into a memory of the handheld device 40. The scanner 42 may be attached via an interface 43.

At a store 50, for example a supermarket, electronics goods store or boat or automobile sales store, the user can select a good or goods to purchase and then checkout at a checkout device 52, which may for example simply be a sales office in a store selling larger goods, or a supermarket checkout counter or any other store location where the customer typically provides payment information.

Checkout device 52 is provided with a communications interface 54 to read the advertising data from the handheld device 40 of the customer 44. In this embodiment, the advertising data may have included a coupon, or points for a loyalty program, such as TIMESPOINTS from the New York Times, or a CVS Store EXTRACARE. Such a loyalty program preferably is run by the advertiser, the advertisement publisher, or the store 50. Coupons typically but not necessarily are provided by the advertiser. Such incentives provide an incentive for the customer 44 to provide the advertising data in the handheld device 40 to the checkout device 52 at checkout.

The checkout device 52 also typically has a payment device 56, such as a debit or credit card reader. This payment device 56 can provide limited user information. The interface 54 and payment device 56 can be integrated into a single device.

The checkout device communications interface 54 may for example read advertising data from the handheld device 40 via a communications interface 47, which for example can support Bluetooth, infrared or a smart card technology. It is noted that the handheld device at this point need not have the scanner 44. Interface 47 and interface 43 could be one interface as well.

There are two ways in this embodiment that the advertising data is sent to the checkout device 52 from the handheld device 40.

First, the customer 44 can scroll via an input device 46 on the handheld device 40 through the stored advertising data, for example via display information shown on a display 48. The display information is a function of the advertising data, and additional information may be obtained for example through interface of the handheld device with a server having display information. For example, the customer via their home computer and the internet could send the limited scanned advertising data to the server and in return receive additional single media display information such as an image of an actual coupon or the product in the advertisement. In this embodiment, multimedia information typically is not desired as taking up too much memory and space.

The customer 44 can then select advertising data 34 related to a good 59 being physically purchased at checkout in the store 50, the customer 44 leaving the store 50 with the good 59. The customer then can push a button on the input device 46 to send the advertising data to the checkout interface 54, which can then provide the information to a checkout processor 58.

The checkout processor 58 can determine for example if the customer is entitled to a rebate for the good 59 and apply the rebate so that at the payment device 56 the customer 44 pays less for the good 59. The identification of good 59 can occur for example via a barcode reader 55, or input by a store employee. User information or a device ID can be provided via the handheld device 40 and/or by the payment device 56. In addition, the rebate amount can be altered by either the handheld device 40 or checkout device 52, as a function of the information the customer is willing to provide. For example, if the customer 44 provides information on his or her home address, a coupon value can be increased. The customer thus can control the advertising and user or device data sent.

The second way the advertising data can be sent is that the good(s) 59 are scanned via the barcode scanner 55 or good information is entered into checkout device 52 by a store employee, and then the checkout device 52 retrieves the advertising data in the handheld device 40 related to the scanned good information. Such a comparison of the scanned good information and advertising data can take place in the handheld device 40 or the checkout device 52 for example. Since the advertising data may contain UPC code information on the advertised product, the comparison could be a simple numerical matching operation.

Advertising data related to the scanned good information then could be sent via the checkout device 52 together with user or device information and the sales information of the good can be sent to the advertiser 31.

Advertiser 31 can then determine the effectiveness of the advertisement 32, and any coupon or rebate information associate therewith. For example, the advertiser of a cereal could print 10,000 ads stating that a scan will be worth 10 loyalty points or provides a coupon worth 1 dollar, and 10,000 ads stating that a scan will be worth 20 loyalty points or provides a coupon worth 2 dollars, and provide advertising data indicating which of the ads are worth 10 points and which are worth 20 points. The advertiser can then see if the value change alters the response rate to the ads. Moreover, even if the incentives are all the same, the advertiser 31 can track sales at various stores 50. Store information also can be provided to the advertiser 31, so that the advertiser knows where the goods are purchased.

This information is of enormous value to many advertisers and to date has not been captured except via clipped coupons, which are cumbersome and require a large UPC code to be printed and for the customer to clip the coupons. The present invention permits easy scanning and collection of not just coupon data, but also loyalty points and other data, and the advertising data can be provided in a visual format such as those described in U.S. Pat. No. 6,448,979 acceptable to almost all advertisements. Feedback from the coupon or loyalty programs can be almost instantaneous. Response rates to such ads can be determined at almost all points of sales, and the present invention can be used in conjunction with e-commerce sales or coupon clipping programs.

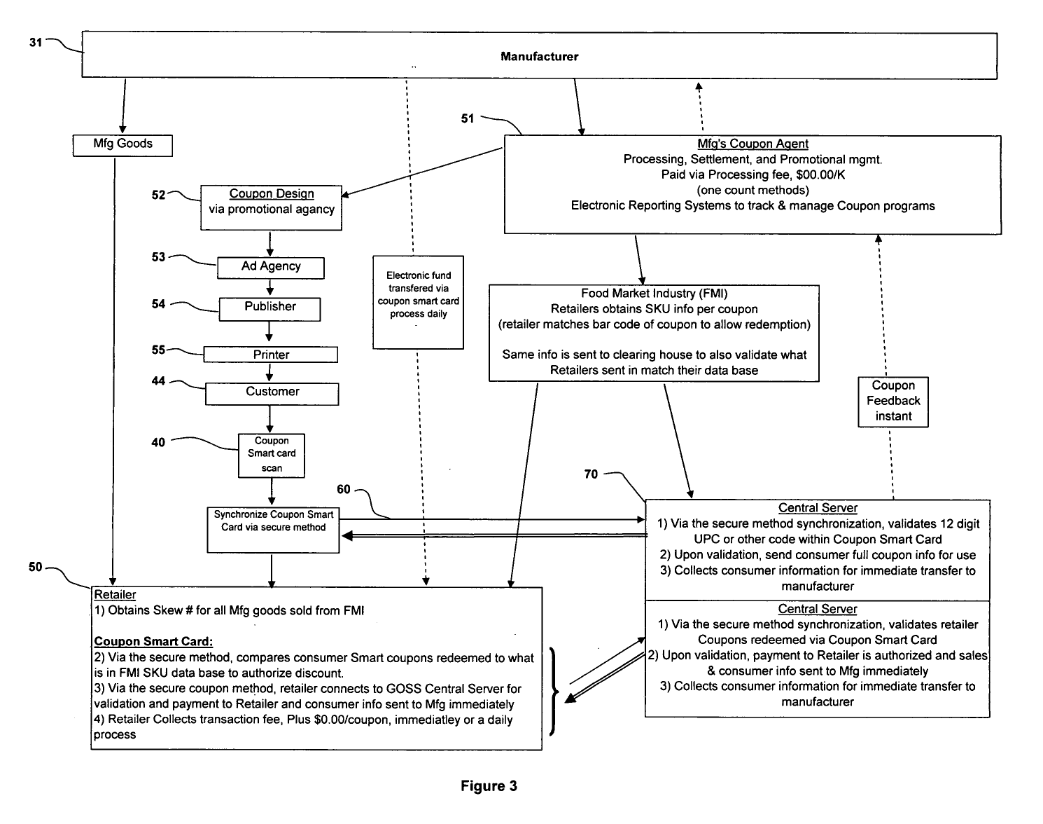

FIG. 3 shows for example one embodiment of a coupon redemption method for the food market industry using a central server. The advertiser 31, here a food goods manufacturer, provides goods to the store 50, which obtains SKU (stock keeper unit) numbers for all the goods. The advertiser 31 also causes the coupon to be printed with an advertisement in steps 52, 53, 54, 55, via a coupon agent 51.

The customer 44 scans the ads with the handheld device 40, here a device which includes a coupon smart card, to obtain the advertising data, which includes the coupon data. In an optional step, the advertiser can require that the coupon data be validated for example via a home computer and internet link 60 to a central server 70. At that point, the advertising data, with or without user data or device ID data, can be collected and forwarded to the agent 51, and the coupon can be validated for full use. Display information or other information can be sent to the handheld device for viewing and/or validation of the coupon.

The consumer 44 can then shop at the retailer 50 and upon checkout, can provide the handheld device 40 with the scanned coupons and receive the rebate as described above. The coupon at this point can be validated by the central server 70, for example by providing the retailer 50 a validation code similar to those provided for credit card purchases. The central server 70 at this time collects the advertising data and user or device ID information, and sales data and store data, for transfer to the agent 51. Feedback advantageous for determining ad effectiveness can occur immediately after checkout. The agent 51 can then provide this information to the advertiser 31 and modify the advertising in response to response rates, for example.

The present invention provides an effective and thorough way to measure effectiveness of almost all print advertisements.

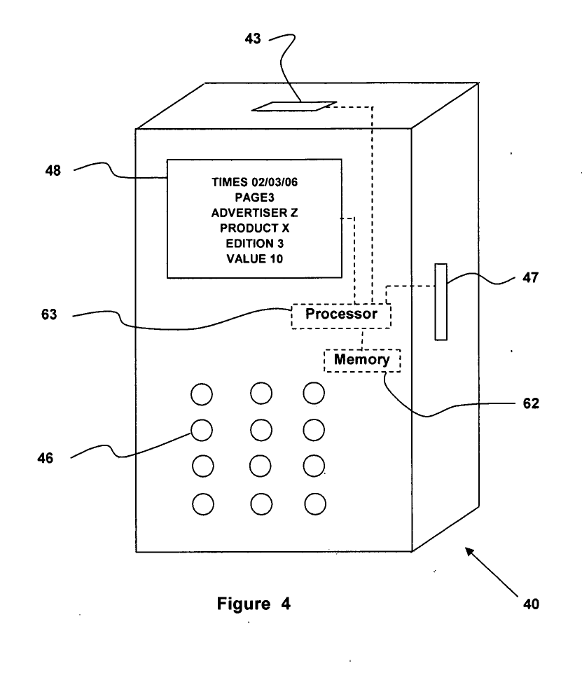

FIG. 4 shows schematically an embodiment of customer handheld device 40 for use at a store checkout, having an input device 46, a display 48, an interface 43 for a scanner for scanning printed advertising data, a memory 62 for storing the advertising data, a processor 63 for receiving input data from the input device and providing the display with display information related to the advertising data, and a communications interface 47 for interacting with a store checkout device and the processor 63. While the display in FIG. 4 is showing the actual advertising data, typically only a part of the data, or display data received from the central server will be displayed, such an image of a coupon similar to coupons clipped from newspapers.

The processor 63 runs a software program, which has steps permitting input of the scanned advertising data and storage in the memory, as well as for the inputting and storing of user or device information. It also may have comparison steps for comparing the stored data with data from the checkout processor and comparison with data input by a user.

The customer can enter in user data for example name, home address, telephone and other contact information into the device 40 via input device 46, for example keys on a cell phone. A personal security code can also be entered and stored.

As one specific example, an advertisement for a cereal brand can be printed with the scannable image TIMES 02/03/06 PAGE3 ADVERTISER Z PRODUCT X EDITION 3 VALUE 10 indicating that Advertiser Z, the cereal manufacturer, had an ad printed in the New York Times on Feb. 3, 2006 on page 3 for product X. The ad was a third edition for that product X, and provided a coupon value of 10 indicating 10 cents off. Obviously a simpler alphanumeric sequence could provide similar information, and can be provided for example via a two-D bar code to minimize space and visual impact.

The customer scans the advertising data when he or she reads the Times, the data then being stored in the handheld device 40. Previously, the customer may have entered in, as a non-limiting example, his or her name, address, telephone number, age and e-mail address or other personal information into the handheld device 40.

At a store, the customer remembers the product X cereal and decides to buy it, and proceeds to the checkout counter. At the checkout, a store employee scans the barcode for product X, which permits the checkout processor to know that product X is being purchased. The customer then states that he has the handheld device 40 and the store employee presses a button to run a coupon check via the checkout device 52 via the interfaces 47, 54. The word “product X” or similar ID is presented to the handheld device, which via its processor 63 then matches this word with the advertising data for product X and sends the product X advertising data to the checkout device 52, which indicates a rebate of 10 cents. The advertising data can be sent to a central server, which verifies that such a coupon value was provided in the advertisement on the proper date and that the coupon has not expired, and a verification code can be sent to processor 58, which upon receipt provides the rebate of 10 cents. The payment device thus requires a payment of 10 cents less. At this point or earlier, the customer also can be queried, for example by the store employee, if he or she would like to provide customer information from a credit card or from the handheld device for a larger redemption. The size of the rebate can depend on the amount of information the customer is willing to provide, for example e-mail only, or e-mail and name. A security code for example can be entered by the customer to permit this information to be transferred to the checkout device 52. The security code could also be required before providing the advertising data. The customer then can pay and leave the store. The advertiser can receive the advertising data, customer information and store information either upon coupon validation or after payment. The store will then receive coupon reimbursement and a processing fee from the advertiser, for example through an electronic fund transfer as shown in FIG. 3.

The scanner may be integrated into the handheld device, and advantageously may be for example a camera of a mobile telephone.

A standalone coupon kiosk can also be provided at the store to interface with the handheld device to show what goods in the store match ads or coupons stored and available on the handheld device. The kiosk may be one of the checkout devices 52 as shown with software which compares the handheld device memory with store SKU information.

What is claimed is:

1. A method for receiving advertising data at a point-of-sale comprising:
inputting good data related to a good at a store checkout via store employee or a store scanner;
comparing the good data to advertising data in a handheld device, the advertising data having been scanned by a customer from a print advertisement with the handheld device;
receiving the advertising data related to the good at the store checkout;
receiving a payment from the customer for the good at the store checkout; and
forwarding the received advertising data and information related to the payment from the store checkout.

2. The method as recited in claim 1 further comprising receiving customer or device information from the handheld device.

3. The method as recited in claim 1 further comprising providing the customer a rebate for the good as a function of the received advertising data.

4. The method as recited in claim 1 wherein the comparing of the good data to the advertising data occurs in the handheld device.

5. The method as recited in claim 1 wherein the comparing of the good data to the advertising data occurs at a processor of the store checkout.

6. The method as recited in claim 1 wherein the advertising data is received via the user selecting the advertising data.

7. The method as recited in claim 1 wherein the advertising data is received as a result of the comparing of the good data to the advertising data.

8. The method as recited in claim 1 wherein the good data is input by scanning a UPC code on the good at checkout using the store scanner.

9. A store checkout device comprising:
a communications interface for receiving advertising data from a handheld device used by a store customer to scan print advertisements, and
a processor for receiving sales information of products purchased by the store customer and forwarding the advertising data and related actual sales data to the advertiser.

10. A customer handheld device for use at a store checkout comprising:
an input device;
a display;
an interface for a scanner for scanning printed advertising data;
a memory for storing the advertising data;
a processor for receiving input data from the input device and providing the display with display information related to the advertising data; and
a communications interface for interacting with a store checkout device and the processor;
the processor receiving a command from the store checkout device or the customer via the input device to identify the advertising data related to a good purchased at the point-of-sale, and subsequently sending the related advertising data to the store checkout device.

11. A system for tracking advertising effectiveness comprising:
a plurality of the handheld devices having scanned advertising data from printed advertisements of advertisers; and
a plurality of checkout devices in stores, the checkout devices having a communications interface to provide the advertising data and actual sales information to the advertiser.

12. The system as recited in claim 11 further comprising a kiosk for providing the user with information about the store goods

13. A method for tracking advertising effectiveness comprising:
placing an advertisement for goods in a printed publication, the advertisement including advertising data to be scanned by a handheld scanner of a customer;
sending the goods to stores; and
receiving the advertising data for the goods and store sales information related to the goods, the advertising data having been provided at a store checkout device of the goods.
